(19) United States
(12) Patent Application Publication
(10) Pub. No.: US 2023/0123905 A1
(43) Pub. Date: Apr. 20, 2023

(54) METHOD & APPARATUS FOR PRODUCING A VIDEO IMAGE STREAM

(71) Applicant: GET SAAVY GROUP LIMITED, Leeds West Yorkshire (GB)

(72) Inventor: James LUNN, Leeds West Yorkshire (GB)

(21) Appl. No.: 17/905,838

(22) PCT Filed: Mar. 11, 2021
(86) PCT No.: PCT/GB2021/050611

§ 371 Date: Sep. 8, 2022

(30) Foreign Application Priority Data
Mar. 11, 2020 (GB) 2003557.2

(51) Int. Cl. G06T 19/20; G06V 20/20; G06T 7/246; G06Q 30/0251; G06Q 30/0601

(52) U.S. Cl. CPC G06T 19/20; G06V 20/20; G06T 7/251; G06Q 30/0269; G06Q 30/0631; G06T 2219/2024; G06T 2219/2021; G06T 2210/16

(57) ABSTRACT

Methods and apparatus are described for producing a computer-generated image by monitoring one or more kinds of activity of a user to identify at least one item of interest; and creating a computer-generated image including a representation of the item of interest overlaid onto an image of a model, environment or contextually relevant scenario. The process begins at 102 with monitoring a user's online activity. Software tracks and stores which purchasable items on the website/mobile application the user appears to be most interested. In a particular example, a user's abandoned basket feed is tracked and stored. In another example, cookies information is stored. Another indicator of items that a user is most interested in is length of time browsing a webpage associated with a particular item. Dwell time and cursor tracking software may also be used to identify which items the user viewed most. At 114, a model simulation is created. The object to be modelled relates to the items of interest. In the example where the items of interest are wearable items such as clothing garments, the model to be simulated is a human person said human person resembling the user as closely as possible based on the available personal data.

The present invention relates to apparatus and a method for producing a video image stream, and is concerned particularly, though not exclusively, with apparatus and a method for identifying a user's item(s) of interest and producing a computer-generated image incorporating the item(s) of interest.

### BACKGROUND

A user browsing an e-commerce site may add prospective purchases to their “basket”. The basket of an e-commerce site is a linked webpage which stores purchasable items before proceeding to checkout where a transaction for the purchasable items can be completed. Often a user leaves the site without completing the purchase of items in their “basket” The user may never return to the site, may clear their basket on next viewing of the site or the basket may be refreshed by the site after a period of inactivity. In all of the preceding scenarios the user does not go through with the purchase of the items they selected. It is desirable to improve the percentage of items that are save to basket that go through to a full sale.

Currently, site cookies save data on the purchasable items that a user has viewed and presents the items back to them in studio “flat lays” of the individual item in an inline frame to re-inspire a user to purchase said item. Described herein is a method to produce a highly personalised video image incorporating items a user has viewed online.

Embodiments of the present invention aim to at least partly address the aforementioned problems and, more particularly to provide a highly personalised video image stream incorporating purchasable items that a user has viewed online to more effectively re-inspire the user to purchase said items than may be achieved from a “flat lay” image.

The present invention is defined in the attached independent claims, to which reference should now be made. Further, preferred features may be found in the sub-claims appended thereto.

### SUMMARY OF THE INVENTION

According to one aspect of the present invention, there is provided a method of producing a computer-generated image, the method comprising: monitoring one or more kinds of activity of a user to identify at least one item of interest; and creating a computer-generated image including a representation of the item of interest overlaid onto an image of a model.

The model may comprise a thing, person, environment or contextually relevant scenario.

The image may comprise a video stream. The user's activity may include online activity and/or physical locations visited.

The image of the model may comprise a computer generated image or a real image.

The image may comprise a combination of real and computer generated images.

The method may further comprise one or more of the following steps: collecting and storing data of the at least one item of interest; retrieving personal and/or contextual data about the user from at least one of an online source and a dataset; selecting a three-dimensional model simulation from a database of three-dimensional model simulation files; selecting an action simulation for the model simulation to perform from a database of stock action files, the selected action being at least partly based on contextual data of the user; retrieving an item image file of the at least one item of interest from a database of item image files based on the stored data of the at least one item of interest; applying an item-specific dynamics model and a motion tracking model to the item image file; compiling the selected model simulation, action simulation and image file to create the single computer-generated video image stream.

The method may further comprise applying an item-specific texture simulation to the item image file before compiling the image.

The user's online activity may include items viewed on an eCommerce site.

The ecommerce site may be a retail site and the at least one item of interest may be a garment.

The model to be represented may be a human model.

The human model may be created using a three-dimensional person simulator at least partly based on the personal data.

The personal data may comprise at least one of user age, height, clothes measurements, race, body type, and gender.

The item image file may comprise a fabric pattern image of the garment.

The item-specific dynamics model may be a fabric dynamic model.

The item-specific texture simulation may be a fabric texture simulation.

The stock action files may comprise three-dimensional pre-recorded motion tracking data.

The model simulation files may comprise pre-recorded lighting data.

The method may further comprise rendering a background to the video image stream, the background selected from a database of pre-recorded background images based on contextual data on the user.

The contextual data on the user may comprise at least one of location, time of day, time of year, local weather conditions and address.

The method may further comprise retrieving situational data about the user from at least one of an online source and a dataset.

Situational data may comprise life events that the user is experiencing.

The method may further comprise rendering the video image stream in a cloud environment.

The method may further comprise delivering a rendered video image through to a video service for serving of the video in an inline frame to the user.

According to a second aspect, the invention comprises an apparatus for creating a computer-generated image, the apparatus comprising:
a monitoring unit for monitoring one or more kinds of activity of a user to identify at least one item of interest; and
a compilation module for creating a computer-generated image including a representation of the item of interest overlaid onto an image of a model.

The model may comprise a thing, person, environment or contextually relevant scenario.

The apparatus may be arranged to create an image comprising a video stream. The user's activity may include online activity and/or physical locations visited.

The image of the model may comprise a computer generated image or a real image. The image may comprise a combination of real and computer generated images.

The apparatus may further comprise one or more of: a first data storage unit for storing the collected data relating to at least one item of interest; a data retrieval unit for retrieving personal and/or contextual data about the user from at least one of an online source and a dataset; a second storage unit for storing a user's personal and/or contextual data; a first database of three-dimensional model simulations and a first processing unit for selecting a model simulation selected from the first database of three-dimensional model simulation; a second database of stock action files of actions for the model simulation to perform and a second processing unit for selecting an action file from the second database, the action selected at least partly on contextual data; a third database of item image files and a third processing unit for retrieving an item image file of a computer image of the at least one item of interest from the third database; a fourth processing unit for applying an item-specific dynamics model and a motion tracking model to the item image file; and wherein the compilation module compiles the selected model simulation, action file and item image file into the single computer-generated video image stream.

The apparatus may further comprise a cloud environment module for rendering the image as a video image file.

The apparatus may further comprise a video delivery module for delivering the rendered video through to a video service for serving of the video in an inline frame to the user.

The invention also includes a program comprising instructions that, when executed on a processor, performs a method described herein preferably using the apparatus described herein.

The invention also includes a computer-generated video image stream created using a method described herein.

The invention may include any combination of the features or limitations referred to herein, except such a combination of features as are mutually exclusive, or mutually inconsistent.

### BRIEF DESCRIPTION OF THE DRAWINGS

A preferred embodiment of the present invention will now be described, by way of example only, with reference to the accompanying diagrammatic drawings, in which:

FIGS. 1a and 1b show a flow chart schematically illustrating a method of producing a computer-generated video image stream according to an embodiment of the present invention;

FIG. 2 shows an item image file and the item image file incorporated onto a simulated human model;

FIG. 3 is a flow chart diagram showing how the computer-generated video image stream interacts with a video service for serving a video in an inline frame;

FIG. 4 shows three examples of items of interest on a user interface;

FIG. 5 shows a webpage with a main content and displayed video image streams; and

FIG. 6 shows a schematic of apparatus for creating a computer-generated video image stream.

### DETAILED DESCRIPTION OF PREFERRED EMBODIMENT

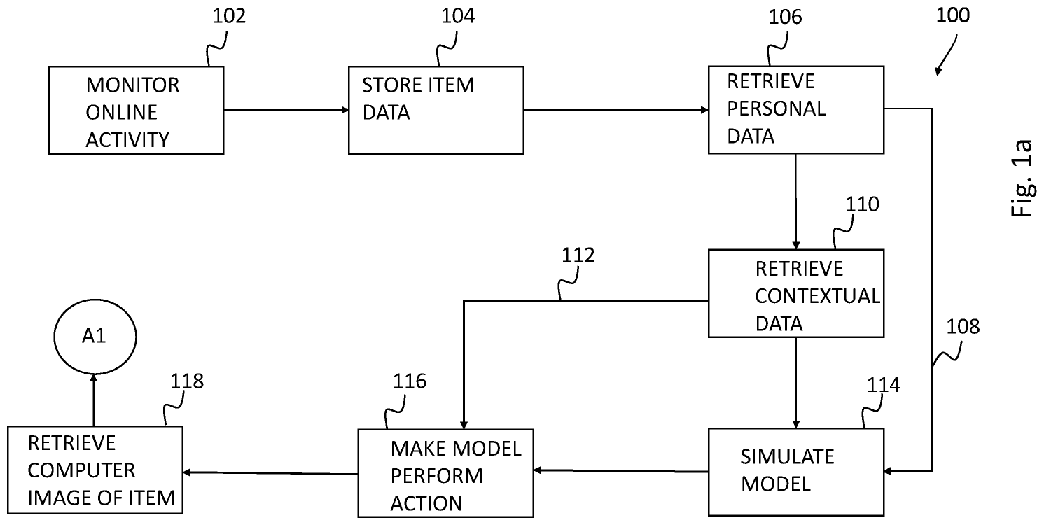

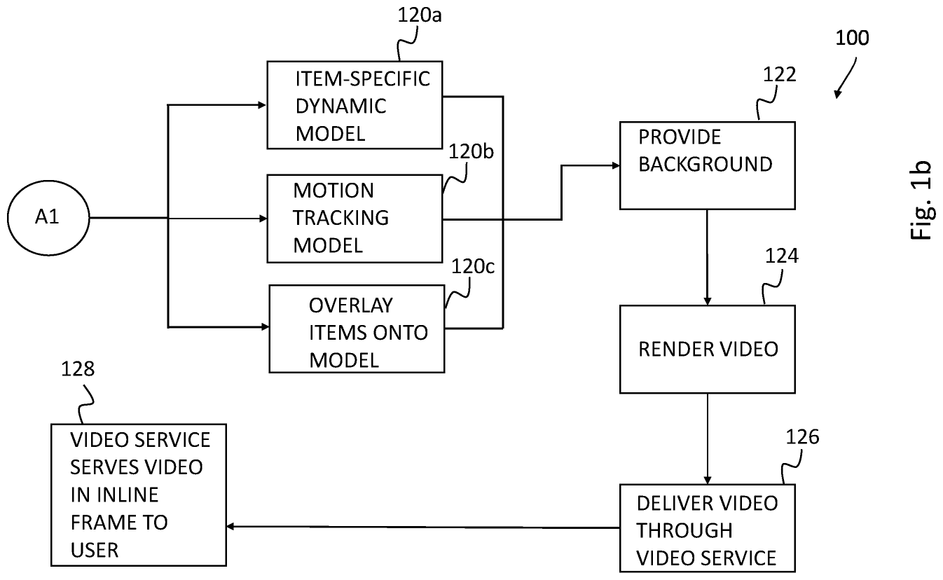

Referring to the flow chart 100 in FIG. 1a and FIG. 1b, the process begins at 102 with monitoring a user's online activity. Software tracks and stores which purchasable items on the website/mobile application the user appears to be most interested. In a particular example, a user's abandoned basket feed is tracked and stored. In another example, cookies information is stored. Another indicator of items that a user is most interested in is length of time browsing a webpage associated with a particular item. Dwell time and cursor tracking software may also be used to identify which items the user viewed most.

A user's physical location may also be monitored, for example to identify stores that the user visits in person. Various examples of mobile phone tracking software are available which can provide this data. The data may then be used alone or in conjunction with data gathered from other sources to identify an item of interest.

Once items of interest have been identified by any of the above described methods, data of the item(s) of interest is stored 104 in a storage device such as a server or cache folder. At 106, personal information relating to the user is retrieved from at least one online source. Examples of personal data include, but are not limited to: age, dress size, height, race, body type and gender. Online sources may include social media platforms such as Instagram®, Facebook®, Snapchat®, YouTube® and Twitter®. Personal and/or behavioural data may also be retrieved and cross referenced from other third party datasets.

At 110, contextual data relating to the user is retrieved from at least one source. Contextual data includes, but is not limited to, location, real time weather forecast, time of day. Situational data relating to the user may also be retrieved. Situational data relates to the user's personal circumstances. A user's relationship status, whether they own a dog, whether they have kids, whether they have an invite to attend a function in the near future are some non-limiting examples of a user's situational data.

At 114, a model simulation is created. The object to be modelled relates to the items of interest. In the example where the items of interest are wearable items e.g. clothing garments, the model to be simulated is a human person said human person resembling the user as closely as possible based on the available personal data.

Once the model has been simulated, the model is programmed to perform 116 an action. The action is selected from a database of pre-programmed actions based on which action is most relevant to the consumer based on personal information, contextual information and/or situational data.

The selected action may also take into consideration the nature of the items of interest. For example, if the items of interest are athletic clothing, then the human model may be programmed to be perform a running action, if the items of interest include a party dress the human model may be programmed to perform a dancing action.

In the example where the item of interest is a city car, the action may be parallel parking. For an off road vehicle, the action may be driving over an undulating surface.

At 118, a data code for each item of interest is compared to a data code relating to a database of computer rendered images of a selection of items of interest.

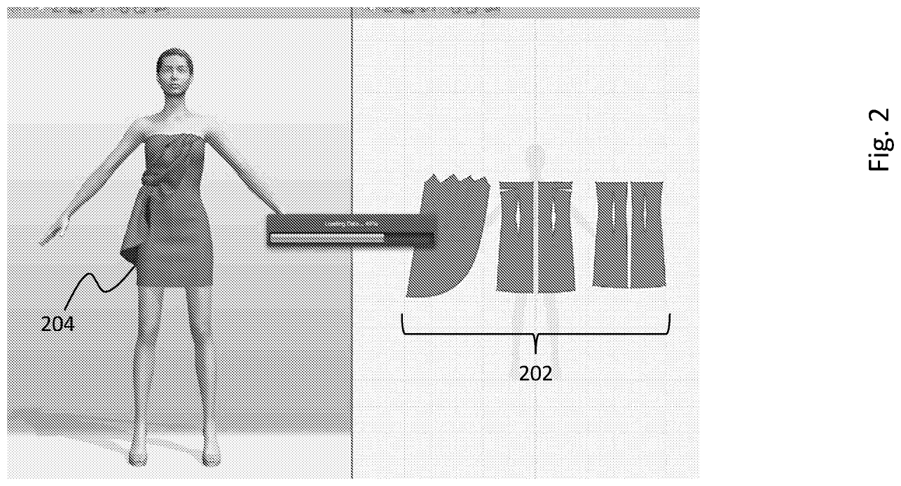

In FIG. 2, the items of interest are clothing. The computer rendered image is of a flat pattern 202 of the clothing item. This pattern 202 is then digitally reconstructed 204 onto the human model. Where the items of interest do not constitute a full outfit, further garments may be selected from a database of additional garments to provide a full outfit including the items of interest. For example, if the items of interest were a cardigan and a pair of trainers, additional garments: a pair of jeans and a shirt may be selected from the database to create a full outfit. The full outfit including the items of interest is then digitally reconstructed 204 onto the human model. Additional garments that are used to provide a full outfit may be selected based on personal, contextual and/or situational data. For example, a first user may be a young woman and a second user may be a mature woman. An item of interest identified for the first user may be paired with additional garments that consider the woman's age and what is deemed a preferred style for that age range. An item of interest identified for the second user may be paired with additional garments that also consider this woman's age and what is deemed a preferred style for that age range. For example, if the item of interest is a t-shirt the item may be paired with the additional garment of a long skirt for the second user and a short skirt for the first user. A different outfit may be presented to two separate users even if they have selected the same combination of items of interest. The different outfit arises since the items of interest are paired with different additional garments based on the individual user's personal, contextual and/or situational data.

At 120, the illusion of the simulated video image is refined by adding a motion tracking model and an item-specific dynamics model. The motion tracking model ensures that the item moves along with the model when the model is performing the selected action. The item-specific dynamics model ensures the item response to the moment of the model as it would do in a real-life scenario. The motion tracking model and the item-specific dynamics model give the viewer the illusion of viewing a real-world video image stream. The illusion of the video image stream may be further improved by adding a materials rendering model. This model produces a realistic impression to the materials that make up the item of interest.

In the example that the item of interest is clothing, the items will be items of clothing: t-shirts, dresses, coats, trousers etc and will motion track a human model performing an action. Taking a dress as a specific non-limiting example, the dress will move with the human model. The dress will have fixture points which fix the dress to the model, for example, at the shoulders and around the waist. The rest of the material will follow these fixed points based on momentum from the performed action, gravity and the material of the dress and is dictated by the item specific dynamics model in the form of a fabric dynamic model. The material rendering model will accurately simulate the materials of the dress in the form of a fabric renderer. The fabric renderer includes sheen, weave, texture and refraction of light. In essence, the fabric renderer ensures a true representation of what fabric and materials look like in real life.

The next stage to creating a computer-generated realistic video image stream related to the user is to provide 122 a contextualised background environment to the video. The context of the background will be specific to the user and may be derived from personal, contextual and/or situational data. For example, if the user lives in London and it is winter the background may be a snowy Oxford Street. The background may also take into consideration the item of interest. For example, if the item of interest is a bikini, the background may be a sunny beach in Ibiza.

The entire video file is rendered in a cloud environment 124. The video image is then delivered 126 through a video service. The video service serves 128 the video in an inline frame to the user. The inline frame could be an Instagram® story advertisement, a Google® display advertisement. Again, the choice of hosting platform for the inline frame can be based on contextual information.

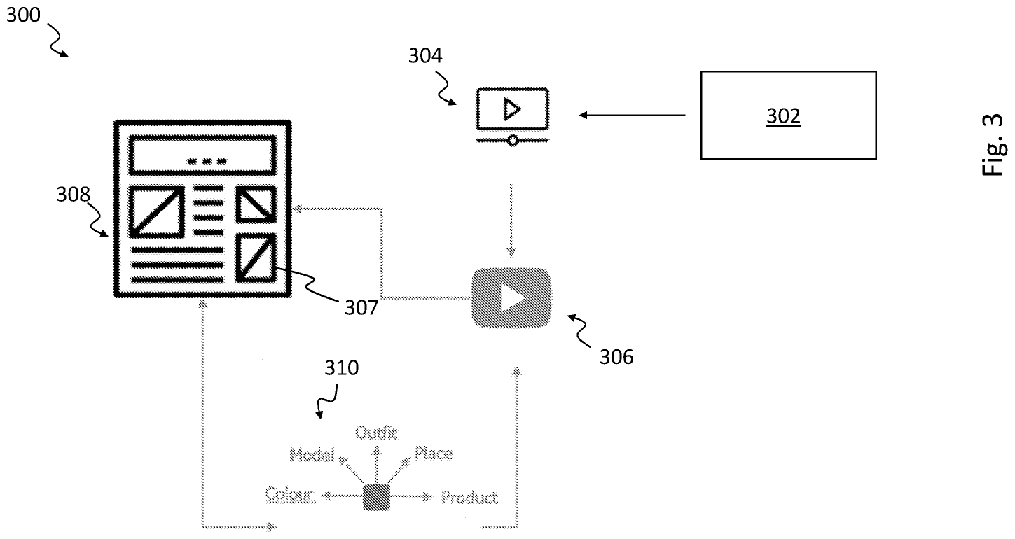

FIG. 3 show a flow chart diagram 300 of how the computer-generated video image stream interacts with a video service for serving of the video in an inline frame. At 302, the apparatus 302 creates a computer-generated video image stream based on artificial intelligence. The apparatus 302 sends the video image stream to a video rendering service 304 which renders the video and uploads the video to a video storage device 306. The video storage device 306 then serves the video in an inline frame 307 of a webpage 308 to be viewed by the user. The information stored in 310 is used to determine the location of the video on the video storage device 306 which is then used to serve the video to the inline frame 307.

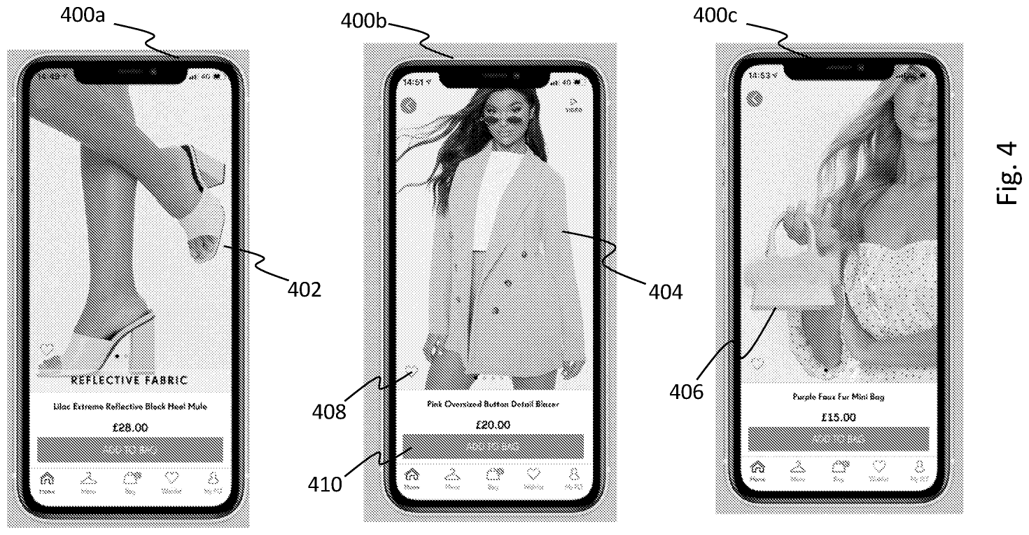

FIG. 4 shows three examples of items of interest 402, 404, 406 on a user interface 400a, 400b, 400c. In this example, the user interface 400a, 400b, 400c is an eCommerce mobile phone application. The item of interest shown in user interface 400a is a pair of shoes 402. The item of interest shown in user interface 400b is a blazer 404. The item of interest shown in user interface 400c is a bag 406. Code, in the form of a “snippet” can record the user's expression of interest in a particular item by recording when the webpage of an item has been viewed, when the user has clicked on an emblem 408 to register an interest in the item, or when the user has added the item to their bag 410, wherein a bag or basket is a cache folder within a user's website account where information can be temporarily saved. The “snippet also puts information in a “cookie” in the form of directions to the video image stream that needs to be served. As described in relation to flow chart 100 in FIGS. 1a and 1b, the information recorded by the code is used to create a computer-generated video which incorporates the items of interest. In the example of FIG. 4, a computer-generated image of the pair of shoes 402, the blazer 404 and the bag 406 will be incorporated into the computer-generated video.

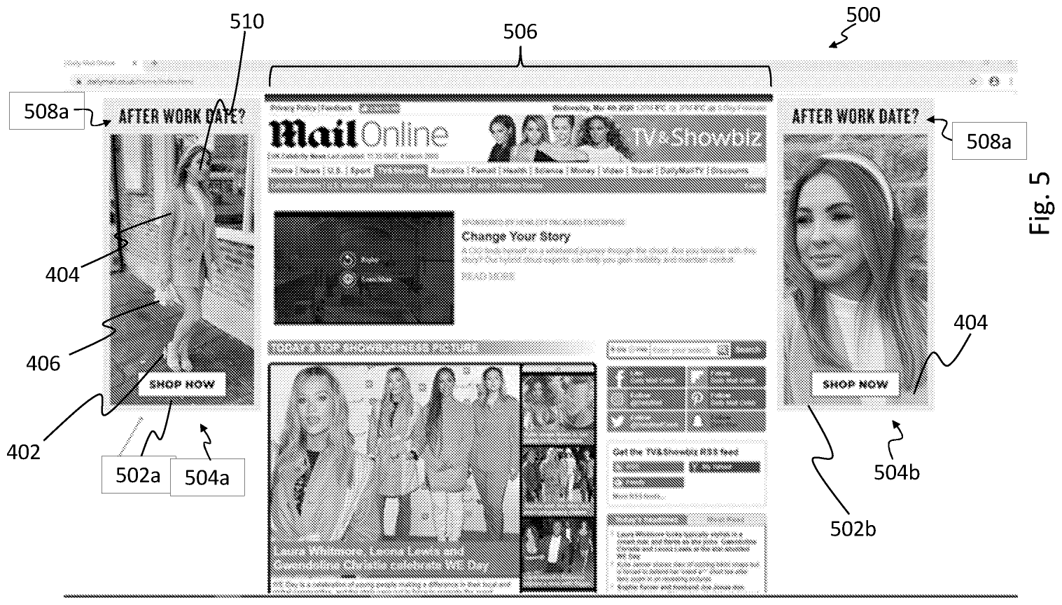

As described in relation to flow diagram 300, once the video image stream has been created it is sent to a video storage device 306 to be served on a webpage 308 in an inline frame 307. FIG. 5 shows a webpage 500 with a main content of the webpage display in section 506. Inline frames 502a and 502b display video image streams 504a and 504b respectively. As shown in video image stream 504a, the items of interest: the pair of shoes 402, the blazer 404 and the bag 406 are visible and are being worn by a human model 510. Since the items of interest do not constitute a full outfit, further garments have been selected from a database of additional garments to provide a full outfit. These further garments are a top, a skirt and a headband.

A caption 508a, 508b relating to the video can be included. In the example video 504a the caption 508a reads “AFTER WORK DATE?”. Example video 504b displays the same “AFTER WORK DATE?” caption 508b. The caption 508a, 508b may be generated based on situational data of the user. In the example of videos 504a and 504b, the situational data that may have prompted the caption 508a, 508b is information that the user subscribes to a dating site, that they have recently changed their relationship status on a social media platform such as Facebook®.

The human model 510 is selected from a database of human models using user related personal data. For example, the human model 510 is a white, 5 foot 7 inch women of slim build aged around 25 years old. Thus, the human model 510 has used variables: ethnicity, height, gender, body shape and age to generate a human model that represents the user.

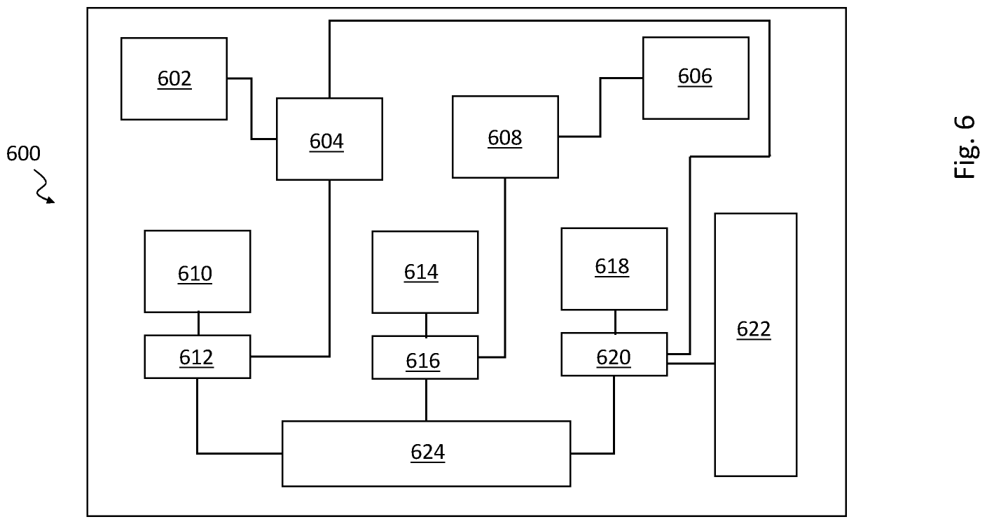

FIG. 6 shows a schematic of apparatus 600 for the creation of computer-generated video image streams as described herein. The apparatus 600 has a monitoring unit 602 for collecting data of item(s) of interest relating to a user's online activity. The apparatus 600 also has a first data storage unit 604 for storing the collected data relating to the item(s) of interest. The apparatus 600 has a data retrieval unit 606 for retrieving personal and/or contextual data about the user. This data can be retrieved from one or more online sources and/or a dataset. Apparatus 600 has a second storage unit 608 for storing said personal and/or contextual data. The apparatus 600 further includes a first database 610 of three-dimensional model simulations and a first processing unit 612. The first processing unit 612 uses the information of the item(s) of interest to select an appropriate model simulation from the first database of three-dimensional model simulations. For example, if the item of interest is a garment, then the appropriate model simulation would be of a human person whereas if the item of interest is a car then the appropriate model simulation would be a car. A user's personal data may also be used to generate the model simulation. For example, gender, body shape, height and size information of the user can be used to simulate a human model that is representative of the appearance of the user, or of an aspirational appearance. The apparatus 600 further includes a second database 614 of stock action files of actions for the model simulation to perform and a second processing unit 616 for selecting an action simulation file from the stock action files. The action that is selected from the stock action files is at least partly based on contextual data stored in the second data storage unit 608.

The apparatus 600 further comprises a third database 618 of item image files and a third processing unit 620. The processing unit 620 uses the information about the item(s) of interest stored in the first data storage unit 604 to retrieve an item image file of a computer image of the item of interest from the third database 618. The apparatus 600 further includes a fourth processing unit 622 for applying an item-specific dynamics model and a motion tracking model to the item image file. The apparatus 600 includes a compilation module 624 for compiling the selected model simulation, action simulation and image file into a single computer-generated video image stream. The video image stream will display the item of interest overlaid onto the model simulation performing the action.

The method of using artificial intelligence to produce a personalised video image described herein has been described in relation to the online retail industry and the automotive industry. However, the method, apparatus and programme described herein can be used in other industries such as: electronics consumer goods, home furnishings, food and groceries to name a few non-limiting examples.

The term “user” herein may be taken, for example, to mean prospective or actual customer. Composite images may be created which include a representation of an item of interest overlaid/combined with an image of a model, which model may be of a thing, a person, an environment or a contextually relevant scenario. The model may be selected according to the nature of the item of interest.

The images created in accordance with the present invention may be used in an advertising network, such as (but not limited to) the Google (®) Display Network and/or social media platforms such as (but not limited to) Facebook (®) and Instagram (®).

The images may be “stills”—i.e. non-moving images or more preferably moving video images depicting action.

The images may include computer generated images of items, such as garments, in combination with model images, which model images may themselves be real or computer generated.

A user's online activity may be monitored using tracking technology, such as tracking pixels. Physical location of a user may be monitored using mobile (phone) tracking software, so that when a user visits a particular location, such as a store, that data may be acquired and used as part of the process to determine items that may be of interest to the user.

When rendering images of an item of interest, and/or of a model in conjunction with the item, machine learning techniques may be employed such as (but not limited to) Generative Adversarial Network techniques, for example to predict how an item will look and/or move in a particular situation or from a particular angle.

Whilst endeavouring in the foregoing specification to draw attention to those features of the invention believed to be of particular importance, it should be understood that the applicant claims protection in respect of any patentable feature or combination of features referred to herein, and/or shown in the drawings, whether or not particular emphasis has been placed thereon.

1. A method of producing a computer-generated image, the method comprising:
monitoring one or more kinds of activity of a user to identify at least one item of interest; and
creating a computer-generated image including a representation of the item of interest overlaid onto an image of a model.

2. The method of claim 1, further comprising one or more of the following steps: collecting and storing data of the at least one item of interest;
retrieving personal and/or contextual data about the user from at least one of an online source and a dataset;
selecting a three-dimensional model simulation from a database of three-dimensional model simulation files;
selecting an action simulation for the model simulation to perform from a database of stock action files, the selected action being at least partly based on contextual data of the user;
retrieving an item image file of the at least one item of interest from a database of item image files based on the stored data of the at least one item of interest;
applying an item-specific dynamics model and a motion tracking model to the item image file;
compiling the selected model simulation, action simulation and image file to create the single computer-generated video image stream.

3. The method of claim 2, further comprising applying an item-specific texture simulation to the item image file before compiling a video image stream.

4. The method of claim 1, wherein the user's online activity includes items viewed on an eCommerce site.

5. The method of claim 4, wherein the ecommerce site is a retail site and the at least one item of interest is a garment.

6. The method of claim 4, wherein the model to be simulated is a human model.

7. The method of claim 2, wherein:
the model to be simulated is a human model; and
the human model is created using a three-dimensional person simulator at least partly based on the personal data.

8. The method of claim 7, wherein the personal data comprises at least one of user age, height, clothes measurements, race, body type, and gender.

9. The method of claim 2, wherein:
the user's online activity includes items viewed on an eCommerce site; and
the item image file comprises a fabric pattern image of the garment.

10. The method of claim 9, wherein the item-specific dynamics model is a fabric dynamic model.

11. The method of claim 3, wherein:
the user's online activity includes items viewed on an eCommerce site;
the item image file comprises a fabric pattern image of the garment; and
the item-specific texture simulation is a fabric texture simulation.

12. The method of any of claim 2, wherein the stock action files comprise three-dimensional pre-recorded motion tracking data.

13. The method of claim 2, wherein the model simulation files comprises pre-recorded lighting data.

14. The method of claim 1, further comprising rendering a background to the video image stream, the background selected from a database of pre-recorded background images based on contextual data on the user.

15. The method of claim 14, wherein the contextual data on the user comprises at least one of location, time of day, time of year, local weather conditions and address.

16. The method of claim 1, further comprising retrieving situational data about the user from at least one of an online source and a dataset.

17. The method of claim 16, wherein situational data comprises life events that the user is experiencing.

18. The method of claim 1, further comprising rendering the video image stream in a cloud environment.

19. The method of claim 18, further comprising delivering the rendered video through to a video service for serving of the video in an inline frame to the user.

20. An apparatus for creating a computer-generated image, the apparatus comprising:
a monitoring unit for monitoring one or more kinds of user activity to identify at least one item of interest; and
a compilation module for creating a computer-generated image including a representation of the item of interest overlaid onto an image of a model.

21. The apparatus of claim 20, further comprising one or more of the following:
a first data storage unit for storing the collected data relating to at least one item of interest;
a data retrieval unit for retrieving personal and/or contextual data about the user from at least one of an online source and a dataset;
a second storage unit for storing a user's personal and/or contextual data;
a first database of three-dimensional model simulations and a first processing unit for selecting a model simulation selected from the first database of three-dimensional model simulation;
a second database of stock action files of actions for the model simulation to perform and a second processing unit for selecting an action file from the second database, the action selected at least partly on contextual data;
a third database of item image files and a third processing unit for retrieving an item image file of a computer image of the at least one item of interest from the third database;
a fourth processing unit for applying an item-specific dynamics model and a motion tracking model to the item image file; and
wherein the compilation module compiles the selected model simulation, action file and item image file into the single computer-generated video image stream.

22. The apparatus of claim 20, further comprising a cloud environment module for rendering a video image file.

23. The apparatus of claim 20, further comprising a video delivery module for delivering a rendered video through to a video service for serving of the video in an inline frame to the user.

24. A program comprising instructions that, when executed on a processor, performs a method of claim 1.

25. A computer-generated video image stream created using a method of claim 1.
